(19) United States
(12) Patent Application Publication
(10) Pub. No.: US 2004/0117241 A1
(43) Pub. Date: Jun. 17, 2004

(54) System and method for implementing performance prediction system that incorporates supply-chain information

(75) Inventors: Sophia Krasikov, Katonah, NY (US); David M. Chess, Mohegan Lake, NY (US); John F. Morar, Mahopac, NY (US); Senthilnathan Velayudham, Thornwood, NY (US)

Correspondence Address: HARRINGTON & SMITH, LLP, 4 RESEARCH DRIVE, SHELTON, CT, 06484-6212, US

(73) Assignee: International Business Machines Corporation

(21) Appl. No.: 10/317,300

(22) Filed: Dec. 12, 2002

(51) Int. Cl. G06F 17/60

(52) U.S. Cl. 705/11

(57) ABSTRACT

A performance-prediction system (10) includes a performance-prediction service (101). The service includes a performance report processor (106) for gathering information that is relevant to predicting future performance of business entities at least partly by receiving reports of experiences that one business entity has had as at least one of a customer of, or a supplier to, another business entity. The service further includes a supply-chain network architect (107) that is responsive at least in part to the gathered information for inferring at least some probable customer/supplier relationships between at least some of the business entities to derive a representation of a supply-chain network. A performance request processor, database access component and a performance evaluator (108, 109, 110) cooperate to use the representation of the supply-chain network when responding to a query relative to at least one of the reputation or the likely future performance of at least one specified one of the business entities.

### FIELD OF THE INVENTION

This invention relates generally to database query systems and methods, as well as to business methods involving networked computer systems and one or more databases.

### BACKGROUND

One potential barrier to online commerce and dynamic electronic business (e-business) is the difficulty of establishing trust between parties that have not interacted before, and that may be acquainted with each other only by virtue of online catalog listings. In the consumer area, organizations such as the Better Business Bureau aid parties to a potential transaction to evaluate one another, and to estimate how likely a transaction is to be successful. In the business-to-business (B2B) area there exist companies that are developing systems to provide a similar type of rating service by gathering and disseminating information, such as customer satisfaction in previous interactions with suppliers.

Such services, which aid businesses in predicting the likelihood of success of a contract or other transaction conducted with another party, are expected to be important parts of the dynamic e-business environment. One of the key challenges in this area is to make the predictions of these services as accurate as possible. Various methods known in the art include gathering data on the satisfaction of parties in previous interactions with a party in question, processing these data in various ways, and weighting the data according to (for example) how accurately the experiences of the particular reporting party have in the past reflected the success of future transactions.

It is also desirable to provide customers of such a performance-prediction service with a range of ways to access and evaluate the data, so they may make their own customized predictions that match their own needs. Reference in this latter regard may be had to commonly assigned U.S. patent application Ser. No. ______, filed on even date herewith, entitled “System and Method Providing a Performance-Prediction Service with Query-Program Execution”, by David M. Chess and John F.

Morar (Attorney Docket No.: YOR920020285US1).

What is not adequately addressed by the prior art known to the inventors is a system and method that gathers and provides information on supply chains, rather than on specific, individual businesses.

### SUMMARY OF THE PREFERRED EMBODIMENTS

The foregoing and other problems are overcome, and other advantages are realized, in accordance with the presently preferred embodiments of these teachings.

This invention provides an automated, computer-implemented technique to gather information regarding supply chains, rather than only on individual businesses, in order to improve the accuracy of performance prediction of the members of the supply chain associated with a particular subject business.

The use of this invention improves the accuracy of predictions made over a prediction interval by a performance-prediction service, and offers additional information to its customers, by gathering information on supply chains rather than only on individual businesses. A service making use of this invention employs experience reports obtained from buyers, sellers and third parties to automatically track who the suppliers and customers are for a given business, and who are their suppliers and customers (both present and former), and so on. In one aspect this information is used for predicting the future performance of the business. In another aspect this information is made available to customers who issue queries to a database that stores the information.

As an example of the utility of this invention, if a particular business starts to fail and begins providing substandard service, a performance prediction service utilizing this invention may factor this occurrence into its predictions of the future success of the usual customers of that business, as indicated by the businesses that have provided experience reports indicating that they are customers of the now-failing business. A service utilizing this invention may also provide its customers with the ability to directly request predictions of the performance of a member or members of the supply chain around a particular subject business. An example of a query made in this regard could be: “provide a prediction of the performance of Acme Corp, of its suppliers, and of their suppliers, as well as of the performance of its direct customers”.

This invention provides a performance-prediction system that gathers information relevant to predicting the future performance of certain businesses or other entities, at least partly by receiving reports of experiences that one business has had as a customer or supplier of another business. The system then automatically uses at least some of this information to infer at least some probable customer/supplier relationships between at least some of those businesses or other entities, and uses the inferred and other customer/supplier relationship information in responding to queries relative to the reputation or likely future performance of at least some of the businesses or other entities.

For example, the system uses the information relevant to predicting the future performance of certain businesses or other entities when evaluating the reputation or likely future performance of at least some of the businesses or other entities that are customers or suppliers of, or otherwise related by a supply chain to, the certain businesses or other entities.

The system may respond to queries that specify one or more businesses or other entities and a certain range of supply-chain relationships. The information that is returned in the query response includes or is based on information about the one or more businesses or other entities, and about at least some other businesses or other entities that stand in the range of supply-chain relationships to those one or more businesses or other entities.

At least some of the reports of experiences that one business has had as a customer or supplier of another may be received from a third party, instead of directly from the parties to the experience being reported on.

A performance-prediction system in accordance with this invention includes a performance-prediction service. The service includes a performance report processor for gathering information that is relevant to predicting future performance of business entities at least partly by receiving reports of experiences that one business entity has had as at least one of a customer of, or a supplier to, another business entity. The service further includes a supply-chain network architect that is responsive at least in part to the gathered information for inferring at least some probable customer/supplier relationships between at least some of the business entities to derive a representation of a supply-chain network. A performance request processor, database access component and a performance evaluator cooperate to use the representation of the supply-chain network when responding to a query relative to at least one of the reputation or the likely future performance of at least one specified one of the business entities.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein:

FIG. 1 is a simplified block diagram illustrating the architecture of a performance-prediction system that incorporates supply chain information in accordance with this invention;

FIG. 2 is a logic flow diagram that illustrates the operation of a process for receiving reports and updating a supply chain network topology and/or updating the performance of a subject;

FIG. 3 is a logic flow diagram that illustrates the operation of a process for receiving and responding to user requests for information from the system shown in FIG. 1;

FIG. 4 shows the inputs and outputs of an evaluation algorithm for predicting or estimating supply chain performance;

FIG. 5A shows the inputs and outputs of a supply chain topology construction algorithm; and

FIG. 5B shows a portion of an exemplary supply-chain that is constructed and maintained by the Supply-Chain Network Architect 107 component shown in FIG. 1.

### DETAILED DESCRIPTION OF THE PREFERRED EMBODIMENTS

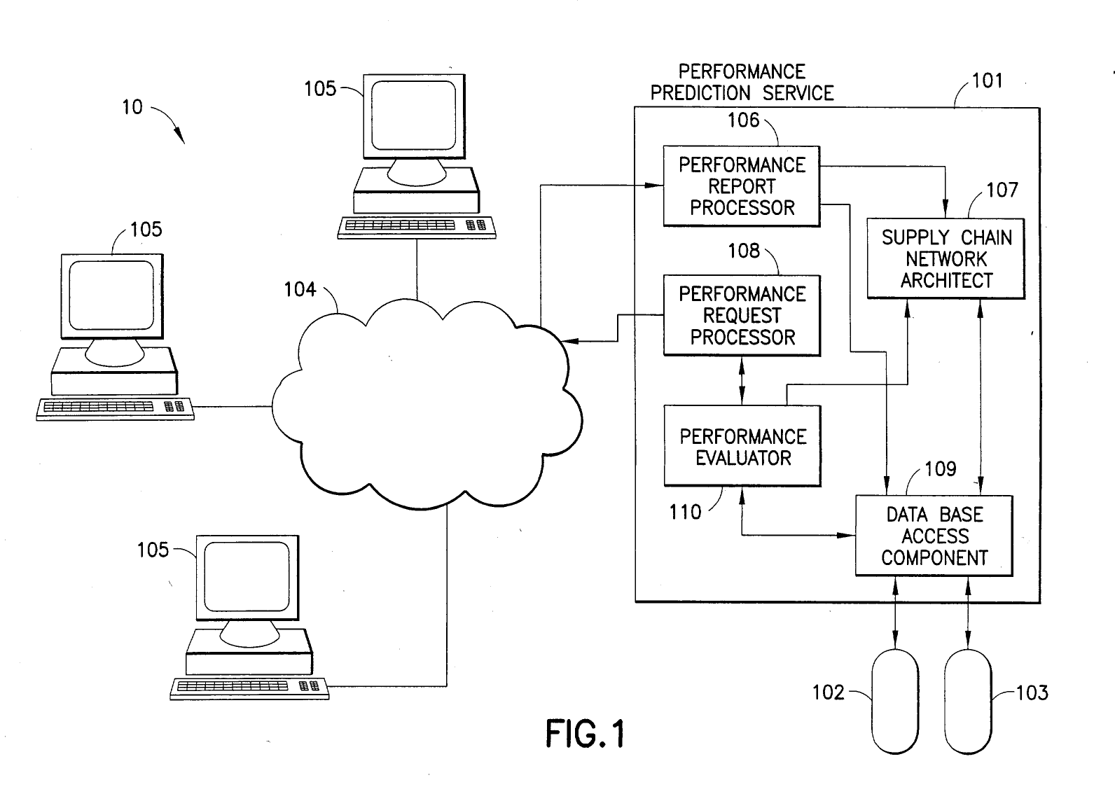

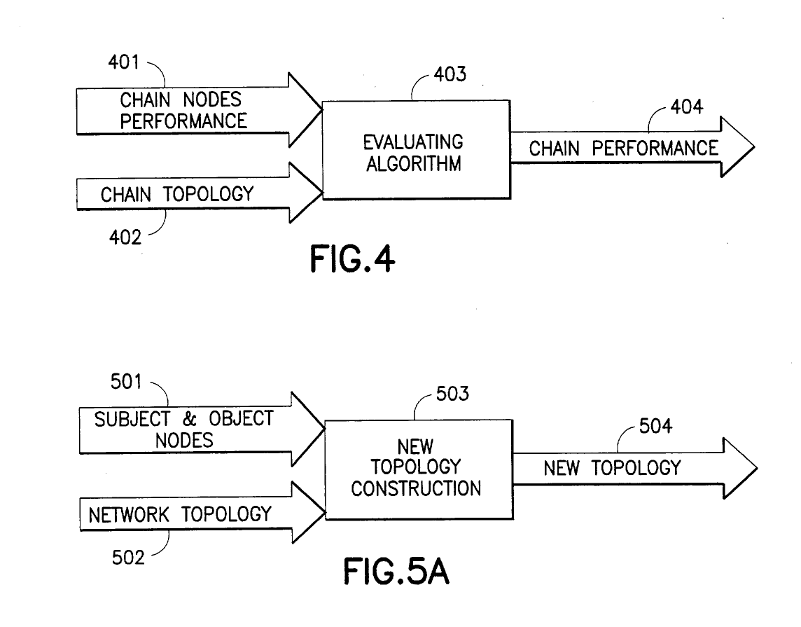

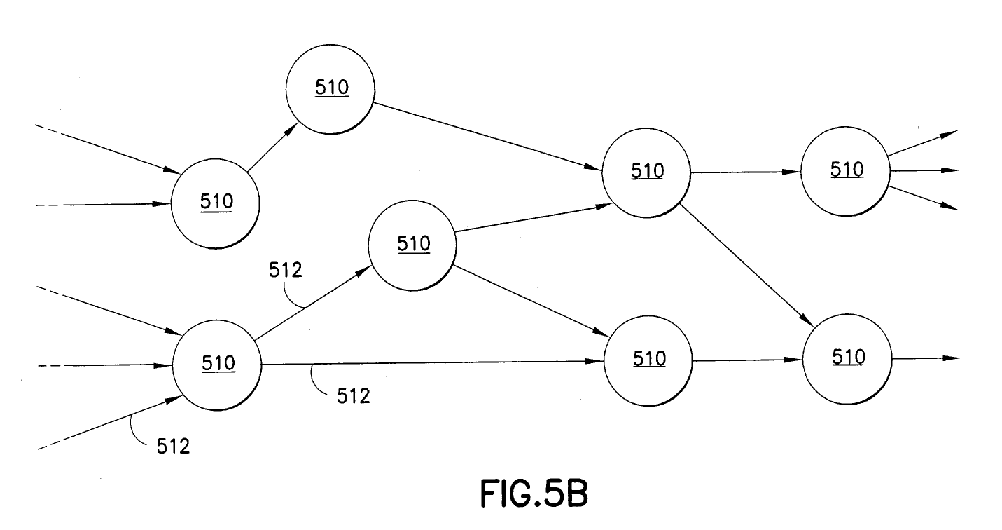

FIG. 1 is a simplified block diagram illustrating the architecture of a performance-prediction system 10 that incorporates supply-chain information in accordance with this invention. The system 10 includes a performance prediction server or service 101 that communicates with customers 105 over a network 104, such as the global Internet. The performance prediction service 101 may be implemented as a computer or data processing system that includes a Performance Report Processor 106 that receives reports from customers 105, a Performance Request Processor 108 that provides customers 105 with requested information, a Performance Evaluator 110 that predicts the performance of a supplier or business utilizing an evaluation algorithm 403 (see FIG. 4), a Supply-Chain Network Architect 107 that executes an algorithm 503 for constructing a representation of a supply-chain network based on reporting and requesting parties and their roles (see FIGS. 5A and 5B), a Database Access component 109 that processes incoming queries and stores and delivers data from both a submitted-report database 102 and a database 103 of other performance-relevant information 103. The various processors and other components mentioned above may be implemented as computer hardware, or as computer software, or as a combination of hardware and software in one data processing system or in a plurality of distributed data processing systems.

In the presently preferred embodiment the customers 105 may submit to the Performance Request Processor 108 at least one of performance requests (asking for an estimate of the likely future performance of a business or a supply-chain) or supply-chain topology requests (asking for the known businesses that have bought from and sold to this business, and possibly further buyer and seller links for some specified distance or number of nodes in either direction along the supply-chain). In other embodiments of this invention the supply-chain information constructed by the Supply-Chain Network Architect 107 may be used only to refine the replies to performance requests made by customers 105, and explicit supply-chain topology requests may not be supported. In a further (non-limiting) embodiment of this invention the customer 105 is enabled to obtain aggregate performance predictions for all the known suppliers, or for all the known customers of a given business, without obtaining the actual identities of those suppliers or customers.

In general, the system 10 is concerned with business entities that are capable of being expressed as a node 510 in a supply-chain topology representation or graph, as in the example shown in FIG. 5B. A business entity may be customer of, or a supplier to, another business entity for goods and/or services. A business entity for the purposes of this invention may be a sole proprietorship, a partnership, a small company, a large multi-national corporation, or any other type of organization.

The business entity may be a for-profit or a not-for-profit organization, and in some embodiments may be a local or national governmental organization or department, or an academic institution, or a charitable institution. That is, a business entity may be any type of person or organization capable of receiving goods and/or services from another person or organization, or any type of person or organization capable of providing goods and/or services to another person or organization.

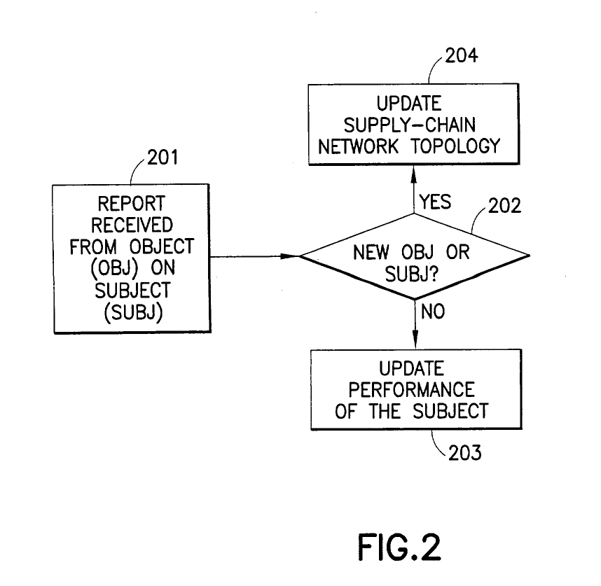

FIG. 2 is a logical flow diagram illustrating one aspect of the operation of the performance prediction service 101 when processing performance reports submitted by customers 105, via network 104, to the Performance Report Processor 106. A customer 105 sends a performance report to the performance prediction service 101 at Step 201. More generally, at Step 201 a report is received from an object (obj) on a subject (subj), and the report is processed by the Performance Report Processor 106. The report is examined at Step 202 to determine if either or both of the object or the subject are new to the performance prediction service 101. In a preferred embodiment of this invention, each party is automatically included in a topological network of the suppliers and customers. As such, if one or both of the parties is new to the service 101, the supply-chain network topology updated at Step 204 by the Supply-Chain Network Architect 107. Thus, in one embodiment of this invention the Supply-Chain Network Architect 107 creates at Step 204 a new buyer-seller relationship between the reporting party and the party reported on, whenever the Performance Report indicates that the reporting party did buy some good or service from the party reported on. The Performance Report is then recorded at Step 203 in database 102. If the subject or object are already known to the performance prediction service 101 at Step 202, control passes to Step 203 to record the Performance Report, without altering the existing supply-chain network topology at Step 204.

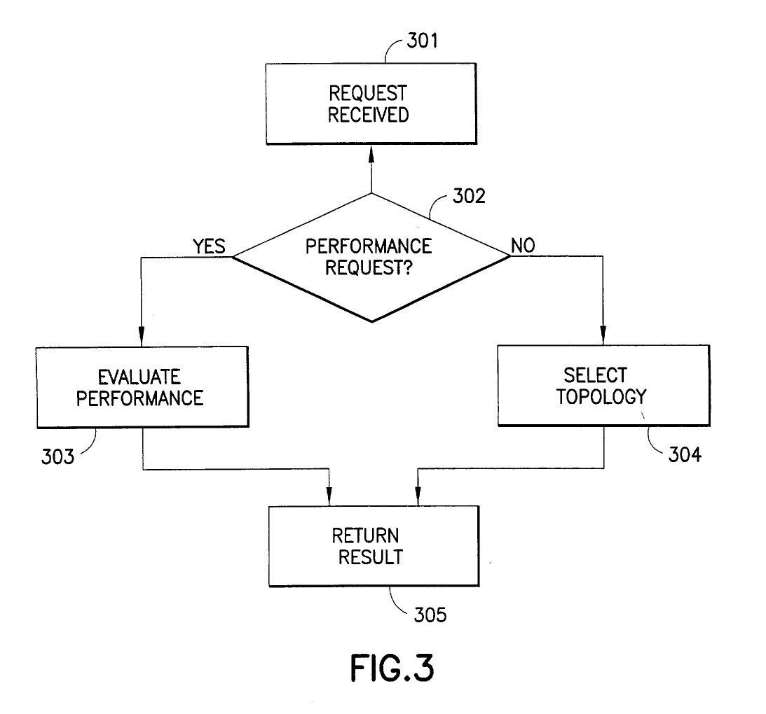

FIG. 3 is a logical flow diagram illustrating another aspect of the operation of the performance prediction service 101 when processing performance requests submitted to the Performance Request Processor 108. When a customer 105 sends a performance request to the performance prediction service 101, it is received at Step 301 and processed by the Performance Request Processor 108. The type of the performance request is examined at Step 302. In the preferred embodiments of this invention, customers 105 may request information regarding either the performance of a supply-chain, or the supply-chain topology around a party of interest (e.g., who sells to Party A, and who does Party A sell to?). Control then passes either to Step 303 to evaluate the performance, or to Step 304 to provide the supply-chain topology, depending on the specific nature of the request received at Step 301 and evaluated at Step 302. In either case the requested result is returned to the requestor at Step 305 (assuming, of course, that the requestor is authorized to both make and receive the request, e.g., the requestor is a client in good standing of the performance prediction service 101).

FIG. 4 is a logical flow diagram illustrating another aspect of the operation of the performance prediction service 101, more specifically the operation of the Performance Evaluator 110. The evaluation algorithm 403 of the Performance Evaluator 110 may utilize methods known in the art for examining and evaluating the performance of the party of interest. This can include processing collected data that reports on the satisfaction of parties in previous interactions, referred to as the chain nodes performance 401 (stored in databases 102 and 103), and processing collected data that relates to the supply-chain topology, referred to as chain topology 402 (also stored in databases 102 and 103). In one embodiment of this invention the Performance Evaluator 110 includes in its evaluation the future performance of a given business based at least in part on estimates of the future performance of the suppliers to that business, as reflected in the supply-chain data maintained by the Supply-Chain Network Architect 107. The results of the evaluation are returned to the original requester 105, referred to in FIG. 4 as the supply-chain performance 404.

FIG. 5A is a logical flow diagram illustrating a further aspect of the operation of the performance prediction service 101, more specifically the operation of the Supply-Chain Network Architect 107. A new topology construction algorithm 503 receives as inputs subject and object nodes 501, derived from the report received at Step 201 of FIG. 2, and the existing network topology 502′. Referring also to FIG. 5B, the new topology construction algorithm 503 operates to add or delete supply chain nodes 510, and to add, delete or modify the connections 512 between the nodes 510, based on the input subject and object nodes 501. The result is a new (revised or modified) supply-chain topology 504 that is maintained by the Supply-Chain Network Architect 107. The connections 512 in FIG. 5B represent relationships (in general) between the nodes 510, i.e., the explicitly defined and implicitly inferred business relationships between the business entities that make up the supply-chain topology 504.

For example, assume that a report received at Step 201 of FIG. 2 states that Company A sells raw material to Company B, or conversely that Company B buys from Company A. If either of these companies are unknown, or if they are known but the business relationship between them is unknown (Step 202), then the new topology construction algorithm 503 of the Supply-Chain Network Architect 107 adds to or otherwise modifies the supply-chain network topology accordingly. The modification may include adding a new supplier to an existing company (adding a new node 510 and a new connection 512 from the new node to the existing node), or adding a new connection 512 from an existing node 510 to another existing node 510.

Having thus described the construction and operation of the performance prediction service 101, several non-limiting examples of its use and utility are now provided.

A growing technology company (Company A) may handle tens of thousands of customer inquiries a day; it may thus find it difficult to trace a customer's interaction history in order to deliver a consistent level of service. To address this problem, Company A desires to purchase a call center system that provides a central repository that is accessible to Company A's entire customer-service function. One of the criteria in choosing a call center system is that the system is already in use by other companies of good reputation. When considering purchasing a particular call center system, Company A (functioning as a customer 105 in FIG. 1) queries the performance prediction service 101 for a list of customers of the company that provides the selected call center system and the reputations of those customers. The query is received and the results returned to Company A, in accordance with the Steps shown in FIG. 3.

As a second example of the use and utility of this invention, assume that a construction machinery Company A in country East X is facing a number of challenges that threaten to undermine its dominance. With the recession that has plagued country East X, company A is looking to reduce its expenses. It has found a lower cost supplier B, but company A knows that supplier B is heavily dependent on its suppliers C, D, and E. Company A therefore desires to obtain performance predictions for supplier B, as well as for the suppliers C, D, and E of supplier B, and any other known suppliers of supplier B. As in the previous example, the query is received and the results returned to Company A, in accordance with the Steps shown in FIG. 3. In this case the performance records of suppliers B, C, D and E are obtained from databases 102 and 103, as previously received in performance reports from companies/customers 105 having experience with one or more of the suppliers B, C, D and E. The supply-chain network topology is also checked for the existence of other suppliers to supplier B that Company A may have been unaware of. If other suppliers are found then their performance records can be obtained as well. If one of the suppliers of supplier B is deemed to be a Critical Supplier (e.g., based on some criteria established by the Company A or by the performance prediction service 101), then the suppliers to the Critical Supplier may be ascertained as well from the supply-chain network topology, and performance reports obtained for them as well.

Assume as another example that Company A is a leading supplier of a wheat-based food product. Assume further that the products of Company A are sold through zone distribution centers, and that Company A has been selected as a major supplier for a new geographical distribution center B. Company A in this case wants assurance that its new customer (distribution center B) is a reputable business. In this case Company A may request the performance prediction service 101 to provide it with the reputation of all of the customers of and the suppliers to the distribution center B. The supply-chain network topology is checked in this case to first determine the identities of the customers of and the suppliers to the distribution center B, and then the databases 102 and 103 are queried to obtain the reputation, or past performance/customer satisfaction, data associated with the identified customers and suppliers of distribution center B.

Assume as one further example that a provider of eBusiness application software (Company A) provides an integrated family of eBusiness application software that enables multi-channel sales, marketing, etc. The eBusiness application software allows a customer to add third-party solutions (companies B, C and D) into the software. This type of partnership (dependency chain) requires compatible system platform architectures and cutting-edge technology. Another company, Company E, is assumed to be in the process of deciding whether to purchase the eBusiness application software of Company A, and thus desires to determine the reputations of the “dependency” partners of Company A. This information is desired, as it is believed by Company E that this information can increase or decrease the reputation value or predicted performance of Company A. In this case the performance records of the dependency partners (companies B, C and D) are obtained from databases 102 and 103, as previously received in performance reports from companies/customers 105 having experience with one or more of the companies B, C and D. The supply-chain network topology may also be checked for the existence of other dependency partners of Company A that Company E may have been unaware of. If other dependency partners are found, then their business reputations can be obtained as well.

Note in this case that if the performance-prediction service 101 was previously unaware that any one or all of the companies B, C and D were dependency partners of Company A, after receiving the performance query from Customer E then the previously unknown relationship(s) may be inferred, and the supply-chain network topology updated accordingly by the Supply-Chain Network Architect 107, in accordance with the method shown in FIG. 5. The same applies to the second example provided above, where if the performance-prediction service 101 was previously unaware that any one or all of the suppliers C, D and E were suppliers to supplier B, after receiving the query from Customer A the previously unknown relationship(s) may be inferred, and the supply-chain network topology updated accordingly.

Note further in this regard that a Company A may report winning customer X's business, and that customer X previously bought from Company B. By this report Company A is providing certain information concerning transactions between Company B and X, even though it was not directly involved in the transactions.

Thus, the relationships 512 between the nodes 510 can be explicitly defined (e.g., Company A says that it sells to Companies B, C and D, and/or that is buys from Companies E, F and G), or the relationships may be inferentially defined as in the preceding example.

Based on the foregoing description it should be apparent that one aspect of this invention pertains to a computer readable media having recorded thereon a computer program for implementing the performance-prediction system 10, in particular the performance-prediction service 101. The computer program includes a first computer program code portion (106) for gathering information that is relevant to predicting future performance of business entities at least partly by receiving reports of experiences that one business entity has had as at least one of a customer of, or a supplier to, another business entity; a second computer program code portion (107), responsive at least in part to the gathered information, for inferring at least some probable customer/supplier relationships between at least some of the business entities to derive a representation of a supply-chain; and a third computer program code portion (108, 109, 110) that uses the representation of the supply-chain when responding to a query relative to at least one of the reputation or the likely future performance of at least one specified one of the business entities.

Based on the foregoing description it should also be apparent that another aspect of this invention pertains to a system and method to provide a service to a customer 105 over the network 104 (such as over the Internet). The method includes receiving a query from a customer, the query identifying at least one business entity; in response to receiving the query, interrogating a database (102, 103) containing information that is relevant to predicting future performance of business entities, the information having been obtained at least in part from received reports of experiences that one business entity has had as at least one of a customer of, or a supplier to, another business entity. The information contained in the database preferably includes supply-chain information that is derived at least in part from probable customer/supplier relationships between at least some of the business entities mentioned in the received reports. The method further, using at least the supply-chain information, returns a query response to the customer 105 that is expressive of at least one of a reputation of, and a likely future performance of, the identified at least one business entity. The method may further include accounting for interrogating the database and returning the query, such as by debiting an account of the customer by some amount of money, and/or by sending an invoice to the customer through the mail or through the network 104.

As such, while described above in the context of presently preferred embodiments, based on the foregoing description and examples those skilled in the art should appreciate that this invention may be expressed in a number of manifestations and alternate embodiments, and that all such manifestations and embodiments will fall within the scope of this invention. Further, it should be realized that the examples of the usage of the system 10 that were given above are in no sense limiting with respect to the possible uses of this invention.

What is claimed is:

1. A method for operating a performance-prediction system, comprising:
gathering information that is relevant to predicting future performance of business entities at least partly by receiving reports of experiences that one business entity has had as at least one of a customer of, or a supplier to, another business entity;
based at least in part on the gathered information, inferring at least some probable customer/supplier relationships between at least some of the business entities to derive a representation of a supply-chain; and
using the representation of the supply-chain when responding to a query relative to at least one of the reputation or the likely future performance of at least one specified one of the business entities.

2. A method as in claim 1, further comprising using information relevant to predicting the future performance of business entities when evaluating the reputation or the likely future performance of at least one business entity that is a customer of or a supplier to, or otherwise related in the supply-chain to, the at least one specified one of the business entities.

3. A method as in claim 1, further comprising responding to a query that specifies at least one business entity and a range of supply-chain relationships, where the information that is returned in response to the query comprises information about the at least one specified business entity and at least one other business entity within the range of supply-chain relationships.

4. A method as in claim 3, where an identity of the at least one other business entity within the range of supply-chain relationships is known a priori to the source of the query.

5. A method as in claim 3, where an identity of the at least one other business entity within the range of supply-chain relationships is not known a priori to the source of the query, and is identified automatically from the representation of the supply-chain.

6. A method as in claim 1, where at least some of the reports of experiences that one business entity has had as a customer of or a supplier to another business entity are received from a third party that was not one of the parties to the experience being reported on.

7. A performance-prediction system, comprising a performance unit for gathering and storing information that is relevant to predicting future performance of business entities at least partly by receiving reports of experiences that one business entity has had as at least one of a customer of, or a supplier to, another business entity; a supply-chain network unit responsive at least in part to the gathered information for determining at least some probable customer/supplier relationships between at least some of the business entities to derive and maintain a representation of a supply-chain network; and a response unit comprising a performance evaluator unit for using the representation of the supply-chain network when responding to a query relative to at least one of the reputation or the likely future performance of at least one specified one of the business entities.

8. A system as in claim 7, where the response unit uses information relevant to predicting the future performance of business entities when evaluating the reputation or the likely future performance of at least one business entity that is a customer of or a supplier to, or otherwise related in the supply-chain network to, the at least one specified one of the business entities.

9. A system as in claim 7, where the response unit responds to a query that specifies at least one business entity and a range of supply-chain network relationships, where the information that is returned in response to the query comprises information about the at least one specified business entity and at least one other business entity within the range of supply-chain network relationships.

10. A system as in claim 9, where an identity of the at least one other business entity within the range of supply-chain network relationships is known a priori to the source of the query.

11. A system as in claim 9, where an identity of the at least one other business entity within the range of supply-chain network relationships is not known a priori to the source of the query, and is identified automatically by the system from the representation of the supply-chain network.

12. A system as in claim 7, where at least some of the reports of experiences that one business entity has had as a customer of or a supplier to another business entity are received by the performance unit from a third party that was not one of the parties to the experience being reported on.

13. A computer readable media having recorded thereon a computer program for implementing a performance-prediction system, comprising a first computer program code portion for gathering information that is relevant to predicting future performance of business entities at least partly by receiving reports of experiences that one business entity has had as at least one of a customer of, or a supplier to, another business entity; a second computer program code portion, responsive at least in part to the gathered information, for inferring at least some probable customer/supplier relationships between at least some of the business entities to derive a representation of a supply-chain; and a third computer program code portion that uses the representation of the supply-chain when responding to a query relative to at least one of the reputation or the likely future performance of at least one specified one of the business entities.

14. A computer readable media as in claim 13, where the third computer code portion further uses information relevant to predicting the future performance of business entities when evaluating the reputation or the likely future performance of at least one business entity that is a customer of or a supplier to, or otherwise related in the supply-chain to, the at least one specified one of the business entities.

15. A computer readable media as in claim 13, where the third computer code portion further responds to a query that specifies at least one business entity and a range of supply-chain relationships, where the information that is returned in response to the query comprises information about the at least one specified business entity and at least one other business entity within the range of supply-chain relationships.

16. A computer readable media as in claim 14, where an identity of the at least one other business entity within the range of supply-chain relationships is one of known a priori to the source of the query, or is not known a priori to the source of the query, and is identified automatically from the representation of the supply-chain by the operation of the second and third computer code portions.

17. A computer readable media as in claim 13, where at least some of the reports of experiences that one business entity has had as a customer of or a supplier to another business entity are received from a third party that was not one of the parties to the experience being reported on.

18. A method to provide a service to a customer over a network, comprising:
receiving a query from a customer, the query identifying at least one business entity;
in response to receiving the query, interrogating a database containing information that is relevant to predicting future performance of business entities, the information having been obtained at least in part from received reports of experiences that one business entity has had as at least one of a customer of, or a supplier to, another business entity, the information comprising supply-chain information derived at least in part from probable customer/supplier relationships between at least some of the business entities mentioned in the received reports; and
using at least the supply-chain information, returning a query response to the customer that is expressive of at least one of a reputation of, and a likely future performance of, the identified at least one business entity.

19. A method as in claim 18, where the query is received from the Internet.

20. A method as in claim 18, further comprising accounting for interrogating the database and returning the query.
